(19) United States
(12) Patent Application Publication
(10) Pub. No.: US 2010/0035027 A1
(43) Pub. Date: Feb. 11, 2010

(54) Tear and Sew Garment label and Method of Producing

(76) Inventor: Dean Hill, New Freedom, PA (US)

Correspondence Address: ECKERT SEAMANS CHERIN & MELLOTT, 600 GRANT STREET, 44TH FLOOR, PITTSBURGH, PA, 15219, US

(21) Appl. No.: 12/536,888

(22) Filed: Aug. 6, 2009

Related U.S. Application Data
(60) Provisional application No. 61/087,011, filed on Aug. 7, 2008.

(51) Int. Cl. G09F 3/00; B32B 27/40; B32B 29/00; B32B 37/00; B32B 38/04

(52) U.S. Cl. 428/195.1; 442/181; 428/423.1; 428/537.5; 156/60; 156/269; 156/252; 156/209

(57) ABSTRACT

A composite tag comprises a woven fabric substrate having a surface, a smooth, pliable urethane coating disposed on the surface of the substrate, a pressure or heat sensitive adhesive disposed on the urethane coating, and a face stock disposed on the adhesive.

### CROSS-REFERENCE TO RELATED APPLICATION

The present application claims priority from U.S. Provisional Patent Application Ser. No. 61/087,011 filed Aug. 7, 2008, the disclosure of which is incorporated herein by reference.

### BACKGROUND OF THE INVENTION

1. Field of the Invention

The invention relates generally to small sheet-like items such as labels, tags, tickets and cards. In particular, the invention relates to fabric labels and tags for garments and other products. More specifically, the invention relates to composite labels and tags having a fabric base adhered to an upper layer of some other material. The invention also relates to a method of manufacturing such composite labels and tags.

2. Background Information

Traditionally, garment tags are made from a generally soft fabric substrate that can be easily attached to a garment by sewing. In addition, the soft corners and edges of such fabric tags reduce wearer discomfort from pricking and scratching, and can be repeatedly laundered without deterioration. Woven fabric tags are generally produced in the form of a continuous fabric strip or tape from which individual tags are cut. Writing and logos are either woven into the fabric strip with yarn of a contrasting color, or printed onto the fabric strip generally through a rudimentary printing process. High-quality and multicolor printing are not possible on such fabric strips generally due to the roughness of the fabric surface and the difficulty of proper register due to the instability of the fabric caused by machinery stresses and environmental changes.

One proposed solution to improve the print quality of fabric tags is to apply a coating to the surface of the fabric before printing. The coating imparts some directional stability and provides a smoother printing surface. Coated fabric garment label stock is available commercially in rolls from several manufacturers. However, the surface of these products is still too rough for high resolution printing, and they are still too dimensionally unstable for the precise registration required by high-quality multicolor printing.

Garment tags are typically provided to clothing manufacturers in packs of individual tags, with each pack including a stack of cut tags contained in a carton or dispenser of some type. In order to attach individual tags to clothing items, a sewing machine operator carefully removes a tag from the carton or dispenser and then attaches the tag to the clothing item. Alternatively, the tags may be loaded into a retainer mounted on an automatic sewing machine which mechanically removes the tags, one at a time, and attaches them to a clothing item.

Counterfeit garments, unauthorized overproduction and diversion of branded products cost brand owners billions of dollars annually. To fight such counterfeiting, brand owners often affix security devices to their products. Such devices, typically individually numbered and/or bar-coded optically variable security devices (such as holograms), are well known in the art, and are often produced and accounted for by a third-party security company on behalf of the brand owner. The security devices are typically delivered to authorized manufacturers as rolls of pressure-sensitive (PS) labels provided on a release backing. The labels are removed from the roll of backing and applied either by hand or by machine during the authorized manufacture of branded goods. However, owners of clothing brands typically prefer their security devices to be sewn in or otherwise permanently attached to their authorized garments, rather than simply stuck on. Further, PS labels do not generally adhere well to most fabrics. As such, it is common to apply security devices to “hang tags” or “swing tags” that are then temporarily affixed to the garments either during or after manufacture. However, it is preferred by brand owners that the security devices be more permanently attached to their garments.

Optically variable security devices are generally produced in plastic film substrates that are not suitable to be sewn into garments directly. Such films are generally comprised of solid layers that when perforated by a sewing needle tend to undesirably fracture and break away along the stitch line. In addition, such films are quite stiff. If a film is sewn into an inside seam of a garment, an attachment method brand owners prefer, the exposed corners and edges of the film tend to irritate the wearer by pricking and scratching the wearer's skin.

A composite film/woven label has generally been successful in solving such sewing and skin irritation issues. Here the security film is applied to a woven material, and the woven tag is then sewn into the garment. The woven material extends beyond the edges of the film on all sides. This tag provides a woven flange on one edge to facilitate sewing, and it provides soft exposed edges where the tag contacts the wearer's skin. Unfortunately, such solution is very time-consuming and costly and thus not desirable for use in typical high-volume applications. In order to achieve sufficient adhesion between the film and the woven material, it is necessary to use a relatively thick layer of heat-sensitive adhesive. A relatively long dwell time is needed to allow the adhesive to heat up so that it will flow between the fibers of the woven material. Further, in production, the woven material is handled in individual pieces, resulting in handling and application that is relatively slow and labor-intensive compared with that of a roll of PS labels.

As such, there remains an unfilled need for an inexpensive security device that can be quickly, easily and cost-effectively sewn into garments.

There also remains an unfilled need for a fabric-based garment tag that is suitable for high-quality multicolor printing.

### SUMMARY OF THE INVENTION

The present invention is directed toward an improved garment tag that includes a fabric base stock that can be quickly and easily sewn into garments, and a face stock of another material with properties suitable for the application of detectable features such as high-resolution printing and optically variable devices.

The invention is in the form of a multi-layer construction, with a base stock, a coating, an adhesive and a face stock. The base stock is a fabric suitable for attachment by sewing, and can be either a woven or a non-woven material. The base stock is then coated to provide a stable surface for the adhesive to sufficiently adhere. The composition of the coating is not critical, as long as it provides an adequate bonding surface and strength to receive the adhesive. For example, without limitation, urethane-based coatings, as well as generic acrylic- and styrene-based latex coatings can be used. More exotic proprietary coatings can also be used. The coated fabric garment label stock that is available commercially works well.

The adhesive should be selected so that it adheres well to both the fabric coating and the material of the face stock. However, as described below, the dwell time of the adhesive (the time it takes the adhesive to set) is critical in the manufacturing process.

The face stock is whatever material provides the final properties needed to incorporate the desired detectable feature. In one embodiment of the invention, the desired feature is an optically variable device, such as a hologram, designed to act as an anti-counterfeit security device. In this embodiment, the face stock is a polymer film that has been embossed to create the desired optical effects. In another embodiment, the desired feature is a high-quality multicolor graphic. In this embodiment, the face stock is a smooth paper or other substrate designed to receive the printing of such graphics.

Also in accordance with this invention, there is provided a method of manufacturing such a tag. First, the fabric base stock is coated, and the face stock is embossed, printed, or otherwise prepared. The two layers are then laminated together with the adhesive. Before the adhesive sets, label areas are die cut from the face stock and the unused waste matrix of face stock is removed and discarded. Various indicia may be printed on either or both the fabric base stock and the remaining label area of face stock. The resulting roll of laminate is then slit into narrow reels a single tag wide. A notable innovation of the process is the creation of a “tear line” between tags adjacent in the web-direction to allow the sewing machine operator to easily dispense the tags when attaching them to garments. The tear line is created during the die cutting operation by making intermittent slit cuts across the web. Alternatively, the slit reels of tags can be rotary cut into individual tags and dispensed in the traditional way.

Advantages of the invention include low cost and ease of use, and the improved quality of its detectable features.

### BRIEF DESCRIPTION OF THE DRAWINGS

The invention will now be described by way of the example of a garment tag with a face stock of polymer film that includes an optically variable device, it being understood that the face stock could in fact be any sheet-like material. Further, one skilled in the art will readily recognize that the use of such labels is not restricted to the labeling of garments. Referring now to the accompanying drawings in which:

FIG. 1 shows a schematic sectional view of a tag in accordance with the invention;

FIG. 2 shows a face view of a web of uncut tags in accordance with an embodiment of the invention;

FIG. 3 shows an axonometric view of a reel of finished tags in accordance with an embodiment of the invention;

FIG. 4 shows a tag attached to an article in accordance with an embodiment of the invention; and

FIG. 5 shows a flow chart of a method of producing a label in accordance with an embodiment of the invention.

### DESCRIPTION OF THE PREFERRED EMBODIMENTS

Since the invention has particular application to garment tags containing optically variable devices or high-quality printed graphics, it will be generally explained in relation thereto. However, within the broadest aspects of the concepts presented, it can be applied to other relatively small, sheet-like items as well.

As employed herein, the term “number” shall mean any non-zero quantity, including one or an amount greater than one.

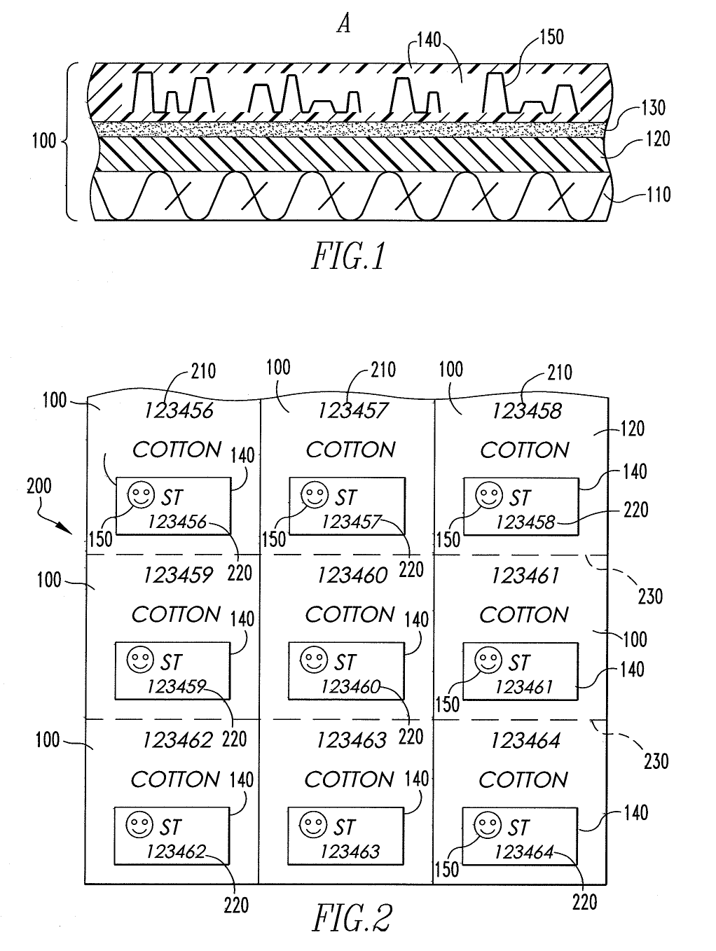

Referring to FIG. 1 of the drawings, a sectional view of a multi-layer tag 100 according to an embodiment of the invention is shown. Multi-layer tag 100 comprises a fabric substrate 110, a coating 120, an adhesive layer 130, and a polymer film 140 that includes an optical device 150. FIG. 2 shows a face view of a web 200 having a number of unseparated tags 100 from the point of view of an observer at point A in FIG. 1.

Fabric substrate 110 may be comprised of any woven or non-woven material suitable for attachment by sewing, and can be made of threads or fibers of any suitable composition. The fabric substrate 110 of FIG. 1 is shown in a stylized manner to emphasize that the surface of such materials is typically rough. Because of this roughness, pressure sensitive labels do not typically adhere well to such fabric substrate 110. The fabric substrate 110 is to be sewn onto an article, such as a garment, shoe, handbag, tarp, tent, or banner. The fabric substrate 110 is coated with a layer of coating 120. The purpose of the coating 120 is to present a smooth surface for printing and the adhesion of a polymer film 140 as will be further discussed.

Coated fabric substrates are well known in the art and are readily available commercially. Such coated substrates are designed for sewing into garments, and are relatively soft on the edges to avoid skin irritation. These substrates were developed to provide a smooth surface for accepting the ink of printed garment care labels. In the present invention, however, the coating is used for another purpose—to provide a smooth surface for the permanent bonding of pressure sensitive adhesives.

As shown in FIG. 2, each tag 200 may include printed indicia 210. Information printed on the surface of the coating may include, for example, care instructions, garment fabric content, country of origin, and size and brand information. In the example shown in FIG. 2, the printed indicia 210 include a unique serial number and the word “COTTON”. Such indicia 210 may be printed with any suitable printing technique, but are typically applied by an offset or flexographic printing method. Of course, the addition of such indicia 210 is not limited to printing processes; for example, indicia may be embossed, hand-written, or even embroidered into the fabric substrate 110 with colored yarn.

Referring again to FIG. 1, a label area of polymer film 140 is affixed to the coating 120 by means of a layer of adhesive 130. The adhesive 130 may be any suitable adhesive material, but is typically of the pressure sensitive variety. As discussed in detail below, the dwell time for the adhesive 130 is critical to the production process, as it must remain only partially bonded until after the die-cut waste matrix is removed.

The polymer film 140 may contain an optical device 150, such as, but not limited to, a hologram, diffractive grating, or microlens array. Such devices are commonly affixed to articles for anti-counterfeit protection or as an ornament, and are well known in the art of security devices. The film 140 may be of any polymer suited to incorporating an optical device. Such films are typically transparent and comprised of polyethylene, polyester or polypropylene. The optical device 150 may be incorporated into the polymer film 140 by any suitable method; typically such devices are embossed, etched, stamped, or injection molded.

In the example of FIG. 2, each polymer film label 140 includes an optically variable device 150 in the form of a graphic logo and text, for the combined purpose of providing ornamentation and discouraging counterfeiting. PS labels that include anti-counterfeiting features incorporated into a polymer substrate are well known in the art and are available commercially on a release backing. As described below, in the present invention, the polymer labels 140 are produced by a method similar to the prior art, but innovative steps are taken to affix them permanently to a coated fabric backing rather than temporarily to a release backing.

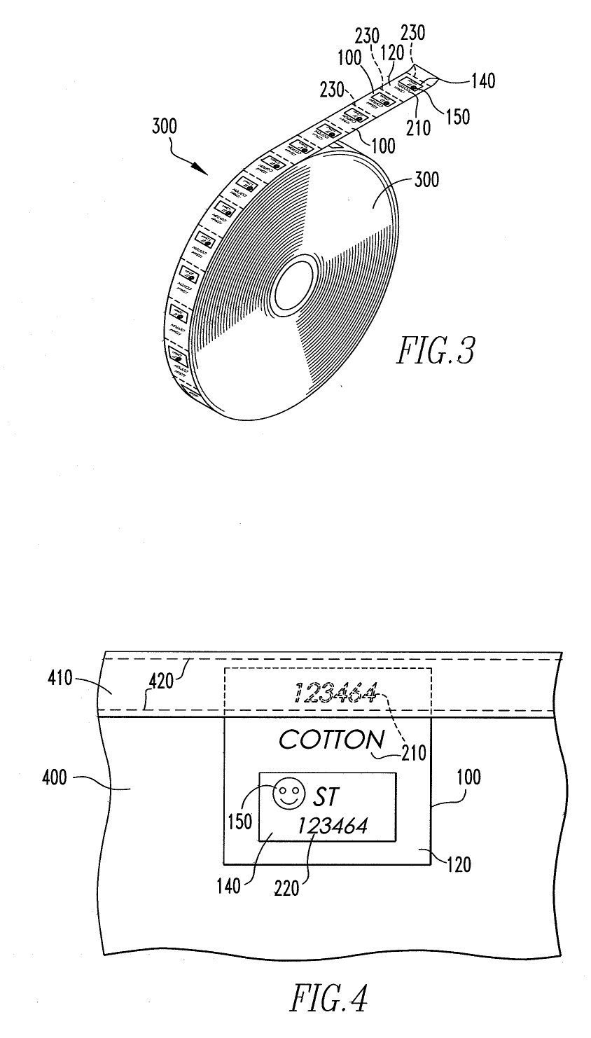

The polymer film label 140 may also include overprinted indicia. FIG. 2 shows an overprinted number 220 that matches the unique serial number of indicia 210 printed on the coating 120. The matching numbers are designed to prevent or discourage counterfeiters and grey market diverters from removing a tag and its tracking number from an article. For additional protection from tampering, the number 210 printed on the coating 120 may be applied on an area of the tag 100 that is not visible to the consumer in the finished article, such as inside a seam, as shown in the example of FIG. 4.

One embodiment of the present invention includes a tear-away feature, illustrated by the die-cut slits 230 in FIG. 2. The tag web 200 is die-cut between each row of tags 100. The length of the die-cut slits 230 are chosen so that the web remains strong enough to pull through roll slitting and winding, yet fragile enough to easily tear into individual tags 100 when sewing to articles. To strike this balance, the length of the slits 230 must be adjusted according to the characteristics of the fabric substrate 110.

FIG. 3 shows a reel 300 of finished tags 100. Each of the individual tags 100 on reel 300 include printed indicia 210 and a label area of polymer film 140 that includes an optical device 150. Adjacent tags 100 are separated by a die-cut tear strip 230. In sewing, the user removes one tag 100 at a time from the reel 300 by tearing at the tear strip 230, analogous to separating individual units from a roll of perforated coil-type postage stamps. The remaining tags 100 in the reel 300 remain attached together for ease of storage and handling.

FIG. 4 shows an individual tag 100 that has been sewn into the seam 410 of an article 400 (e.g., without limitation, a shirt) by stitching 420. The overprinted indicia 220 on the polymer film label 140 include a serial number that matches the serial number of the indicia 210 printed directly on the coated fabric substrate 120. However, the printed serial number 210 is hidden inside the seam 410, so that casual grey market diverters and counterfeiters are ignorant of its existence. Thus, removing the visible part of the tag 100 from diverted goods by simply cutting at the stitching 420 will still leave the serial number 210 inside the seam 410, allowing the number and the good to be tracked. In addition, any attempt to remove the polymer film label 140 with its anti-counterfeiting optical device 150, and place it on a counterfeit article will be easily discovered.

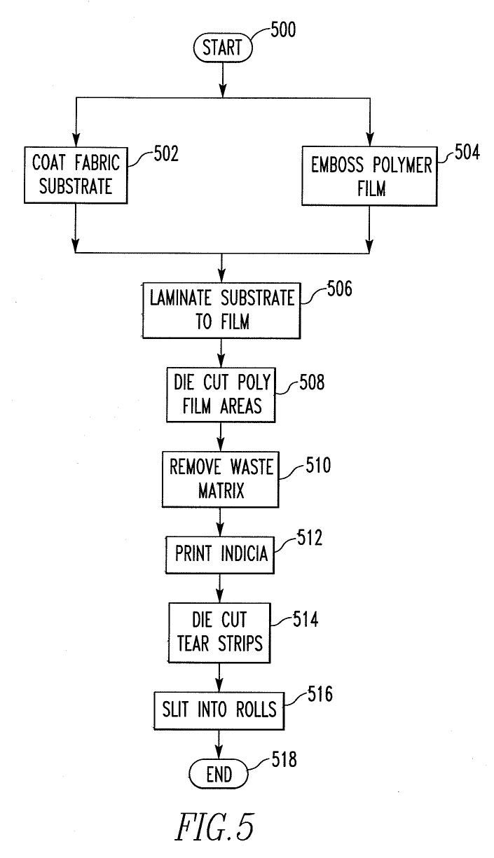

The present invention also provides methods of producing small sheet-like items, such as for example, without limitation, sew-in tags 100 previously discussed. FIG. 5 is a flow chart of a method for producing an embodiment of a sew-in garment tag. The method begins at 500 and comprises coating a fabric substrate with a pliable, smooth coating at 502. In a parallel step at 504, which need not be performed simultaneously with step 502, a web of polymer film is embossed with diffractive gratings to create optically variable devices such as, for example, optical device 150 previously discussed. The optically variable devices may act as anti-counterfeiting and/or ornamental features, and may include images, graphics and/or alphanumeric characters.

At 506, the web of coated fabric substrate is laminated to the embossed polymer film. An adhesive, such as adhesive layer 130 previously discussed, is applied either to the coated (top) surface of the fabric substrate, or to the surface of the polymer film intended to face away from the viewer. Once the adhesive is applied, the two webs are then pressed together to form a multi-layered laminate. In some areas of the finished tag, the coated substrate will be uncovered by the polymer film. Thus, it is necessary to die cut the polymer film so that the unwanted film waste matrix can be removed. The die cutting, at 508, is through the polymer film only and does not penetrate the underlying fabric substrate or coating. The die cutting determines the shape of the label area of polymer film that will remain on the finished tag. The polymer film waste matrix is removed at 510 by a take-up roll.

In the production process, the length of time between the lamination of the coated fabric substrate to the polymer film and the removal of the waste matrix is critical. The lamination, die-cutting and waste removal stations on the production equipment must be in such close proximity, and the web speed high enough, so that the adhesive is prevented from forming a permanent bond between the coated fabric substrate and the waste matrix. Once the waste matrix is removed, the adhesive can form a permanent bond between the coated fabric substrate and the polymer film.

The maximum allowable dwell time for the adhesive used in laminating the coated fabric substrate and the polymer film depends on the characteristics of the adhesive. It has been found that an adhesive with a high initial tack of approximately 550 g/sq cm in combination with a smooth coated fabric surface having an optimal surface energy of approximately 32-38 dyne, will give a very short allowable dwell time of approximately 0.22 seconds. In this example, the minimum required web speed will be higher than it would be for an adhesive with a low initial tack. The minimum web speed is also directly related to the distance between lamination and waste removal. A longer distance between lamination and waste removal requires a higher web speed to keep the dwell time within the allowable range. The maximum allowable dwell time, with pressure sensitive acrylic adhesives and commercially available coated fabric substrates, has been found to be in the range of 0.2 to 0.8 seconds.

Referring again to FIG. 5, at 512 the indicia is printed on the web. Images, graphics and alphanumeric characters may be printed both on the coated fabric substrate and/or the polymer film area. Information printed on the surface of the coating may include, for example, without limitation, care instructions, garment fabric content, country of origin, and size and brand information. In the example of FIG. 2, the word “COTTON” has been printed on the coated fabric substrate, and a unique serial number has been printed on the polymer film label, with a duplicate number printed on the coated fabric substrate. Such indicia can be printed with any suitable printing technique, but offset and flexo methods are convenient and cost-effective.

Providing a duplicate serial number in an area of the tag that will be hidden from view once the tag is attached to an article, such as is shown in FIG. 4, provides an additional level of protection from gray market diversion and counterfeiting. In the case of diversion of brand-named garments, it is common for diverters to cut out any markings or devices that can be used to track the garments through the supply chain. Sewing the unique serial number above a stitch or seam line significantly adds to the time and cost required by diverters to remove tracking numbers from garments.

Once again referring to FIG. 5, at 514 the tear line is formed. A series of slits are die-cut across the coated fabric web between each row of tags. The length of each slit and the distance between them depend on the strength characteristics of the coated fabric substrate. The slits should be cut so that the web remains strong enough to pull through the roll slitting and winding steps, yet fragile enough for individual labels to be easily torn off the roll by end users prior to sewing the individual tag to a garment. It has been found that leaving small tabs of uncut coated fabric substrate spaced across the web can achieve the required balance between adequate web-direction tensile strength and across-direction ease of tearing. The length of the slits, the spacing between slits and the characteristics of the coated fabric substrate are interdependent variables that can be changed to strike this balance. Experimentation has shown that with commercially available coated fabric substrates, the optimum slit length is in the range of 0.100 to 0.125 inch with spacing between slits in the range of 0.005 to 0.015 inch.

It is preferred to die-cut across the web with a rotary die cutting tool. It is further preferred to register the die-cutting with the lineal slitting along the web to ensure that the lineal web-direction slits intersect with the across-direction slits. It has been found that if a lineal slit line intersects an un-cut across-direction slit, the finished labels will not tear away cleanly from the finished roll. In this situation, long frayed fibers remain at the end of the tear line, making the appearance of the finished unit sloppy and undesirable.

In the embodiment of FIG. 5, die-cutting the polymer film 508 and die-cutting the tear lines 514 are discrete steps, separated by the waste removal 510 and printing 512 steps. Two die cutting tools are used. However, both die-cutting steps could be performed simultaneously using only a single die cutting tool. Further, although it is envisioned that a rotary die cutting tool be used for both steps, a flat bed tool could be used as well.

At 516 of FIG. 5, the web is slit between the tags to form small finished reels one tag wide, such as reel 300 of FIG. 3. The finished reels may also be adjusted for length by across-direction cutting or splicing.

While the printing step 512 is shown in FIG. 5 as following removal of the waste matrix 510 and before creating the tear line 514, printing 512 may occur at any convenient time in the process; for example, printing 512 may occur after creating the tear line 514 and before slitting 516.

The method terminates at 518. At this point, the reels of tags are ready for use. The reel may be placed in a holder or receptacle or simply left loose. The user tears off each individual tag from the reel and sews it onto an article.

While the main focus of the development of this novel type of small sheet-like item was security applications in the garment industry, the invention has many other applications. The new method and device is a time and cost-saving improvement for non-security applications as well. For example, high photograph-quality graphics can be inexpensively added to sew-in tags by printing on preferred substrates, applying them to coated fabric substrates, and converting them into finished reels in accordance with the present invention. In addition, the cost and time to apply conventional printed care tags can be reduced by delivering and applying tags incorporating the die-cut tear line feature of the present invention. In this case, the actions of applying the pressure sensitive material to the coated fabric substrate would not be necessary, as the care instructions could be printed directly onto the coated fabric substrate as is done in the prior art.

While embodiments of the invention have been described in varying detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A small sheet-like item comprising:
a substrate;
a smooth, pliable coating disposed on a surface of the substrate;
an adhesive disposed on the smooth, pliable coating; and
a face stock disposed on the adhesive.

2. The item of claim 1, wherein the item is a garment tag.

3. The item of claim 1, wherein the substrate is a fabric.

4. The item of claim 1, wherein the substrate is woven.

5. The item of claim 1, wherein the coating is urethane.

6. The item of claim 1, wherein the adhesive is pressure sensitive or heat sensitive.

7. The item of claim 1, wherein the face stock is paper.

8. The item of claim 1, wherein the face stock is printed.

9. The item of claim 1, wherein the face stock is a plastic film.

10. The item of claim 9, wherein the film contains an optically variable device.

11. A composite tag comprising:
a woven fabric substrate having a surface;
a smooth, pliable urethane coating disposed on the surface of the substrate;
a pressure or heat sensitive adhesive disposed on the urethane coating; and
a face stock disposed in contact with the adhesive.

12. The composite tag of claim 11, wherein the face stock is a plastic film.

13. The composite tag of claim 12, wherein the film contains an optically variable device.

14. A method for producing small sheet-like items comprising:
providing a roll of substrate;
coating the substrate with a smooth, pliable coating; and
laminating a face stock to the coated substrate with a layer of adhesive.

15. The method of claim 14, further comprising:
forming label areas in the face stock by die-cutting the face stock and adhesive layer down to the substrate, the face stock remaining substantially continuous and uncut; and
removing from the substrate the areas of face stock that are outside of the formed label areas.

16. The method of claim 15, wherein detectable features are applied to the face stock.

17. The method of claim 16, wherein the features are printed.

18. The method of claim 16, wherein the features are embossed or molded into the face stock.

19. The method of claim 16, wherein the features are optically variable devices.

20. The method of claim 16, wherein the features are applied to the face stock prior to lamination.

21. The method of claim 16, wherein the features are applied to the face stock after lamination.

22. The method of claim 21, wherein the features are applied to the face stock after die-cutting.

23. The method of claim 15, further comprising:
slitting the roll of laminated substrate and face stock into narrow reels; and
cutting completely across the reel webs to separate the web into individual small items.

24. The method of claim 15, further comprising:
cutting intermittently across the reel webs to form weakened tear lines where the items should be separated from each other;
slitting the roll of laminated substrate and face stock into narrow reels; and
tearing, by hand or by device, across the weakened tear lines to separate the reel webs into individual small items.
